(19) United States
(12) Patent Application Publication
(10) Pub. No.: US 2005/0102903 A1
(43) Pub. Date: May 19, 2005

(54) Door driving control apparatus

(76) Inventor: Hiroshi Takahashi, Tokyo (JP)

Correspondence Address: RABIN & BERDO, P.C., Suite 500, 1101 14th Street, N.W., Washington, DC, 20005, US

(21) Appl. No.: 10/986,463

(22) Filed: Nov. 12, 2004

(30) Foreign Application Priority Data
Nov. 14, 2003 (JP) JP PA 2003-385607

(51) Int. Cl. E05F 15/02

(52) U.S. Cl. 49/28; 318/136; 318/364

(57) ABSTRACT

An apparatus allowing proper compartment door closure, which prevents reduction in voltage of a power source and adverse effects on the operation of other electrical apparatus provided in a same compartment, when trash or deformation of rubber or the like of limited size attached to the end of the door makes the door difficult to close. A door driving control apparatus controls opening and closing of the door by an electric motor. When small foreign matter no larger than a predetermined size is detected to be trapped in the door, a thrust force for driving the door open and closed is switched to high-output thrust force. When a driving-command calculator detects the trapped small foreign matter, the door status data of other doors transmitted from the other doors' driving control apparatus is received. When the door status data shows other doors are not driven to re-opened and close with high-output thrust force, a command for switching to high-output thrust force is provided.

### BACKGROUND OF THE INVENTION

1. Field of the Invention

The invention relates to a door driving control apparatus for controlling the driving of the opening and closing of a compartment door in an electric train or the like, that is opened and closed using an electric motor.

2. The Related Art

As disclosed in Japanese Laid-Open Publication No. 11-180304, a door driving control apparatus for an electric-train compartment (such as a passenger car) connects a plurality of doors (such as the sliding doors through which passengers enter the train car) by serial communication, so that the door status is monitored and opening and closing commands are transmitted, for example. Control of the driving of a door is performed by a train conductor when a person or baggage is trapped in the doors, so that the door is opened or closed again, or is performed automatically by detecting the size of the object trapped, and then automatically opening or closing only the doors in which the object is trapped, so that the trapped object can be removed.

However, when trash, deformation of the rubber attached to the end of the door, or the like causes the door to be difficult to close, the door may not be closed to the “locked” position by merely re-opening or re-closing it. This case is detected as a problem in the door that that could result in stoppage of the train. However, when such a problem is occurs, the door may be properly closed by making the thrust force command value output by an inverter for a normal closing operation, to be higher than the command value for the normal opening and closing operations.

A conventional door driving control apparatus is structured as shown in FIG. 10. In this conventional door driving control apparatus, a plurality of door driving control apparatuses 100-1 to 100-8 are connected to the power source 102 (e.g., battery) that is provided in the same compartment body, e.g. a single electric train car. The power source 102 also is connected to other electrical apparatus (e.g., an air-conditioning apparatus 104, an inverter apparatus for fluorescent lamps 106). Thus, when a high-output thrust force is generated in order to properly close more than one door simultaneously for example, the voltage of the power source is reduced, thus adversely affecting on the operation of other electrical apparatus in the same compartment (e.g., flickering of the fluorescent lamp).

Furthermore, when trash, deformation of the rubber attached to the end of the door, or the like cause foreign matter to be trapped in more than one door simultaneously, the doors are opened and closed through the use of high-output thrust force. This causes a further reduction in the voltage of the power source, resulting in a problem in which the doors cannot be closed properly.

### OBJECTS AND SUMMARY OF THE INVENTION

The invention was made in view of the above. It is an object of the invention to provide a door driving control apparatus that allows, when trash or deformation of the rubber or the like attached to the end of the door, which is insufficient in size to cause an accident but makes the door difficult to close, the door to be properly closed in a manner in which the reduction in the voltage of the power source is prevented and that can prevent adverse effects on the operation of other electrical apparatus provided in the same compartment in which the door is provided.

In order to achieve the above objective, an electric motor driven door driving control apparatus according to a first aspect of the invention, for controlling driving of the door to open and close is provided, wherein when the apparatus detects trapped in the door small foreign matter equal in size to or smaller than a predetermined size, the apparatus switches the thrust force for the driving of the opening and closing of the door to a high-output thrust force so that the door is driven in order to be re-opened and re-closed. The apparatus includes a transmission means for transmitting door status data indicating the status of the door to a door driving control apparatus for controlling an other door in the same compartment. Also included is a means for receiving the door status data of the other doors transmitted from the transmission means of the door driving control apparatuses for controlling the other doors. A check means judges whether foreign matter is trapped in the door. When it does detect foreign matter, it allows the receiving means to receive the door status data of the other doors. When the check means detects from this door status data that another door is not being driven in order to be re-opened or re-closed with a high-output thrust force, it sends a command for switching to a high-output thrust force to the door.

According to this configuration, only one door is always driven in order to be re-opened or re-closed when foreign matter is trapped in one of the doors and the door needs to be driven in order to be re-opened or re-closed. This prevents a plurality of doors connected via wiring to one power source provided in the same compartment from having a reduction in the voltage of the power source caused as in a conventional configuration in which a plurality of doors are driven in order to be re-opened or re-closed simultaneously, thus properly closing the doors.

The reduction in the voltage of the power source is prevented as described above, thus preventing adverse effects on other electrical apparatus even when a power source connected to a plurality of doors is also connected to other electrical apparatus (e.g., a fluorescent lamp, an air-conditioning apparatus).

According to another aspect of the invention, when the check means of the door control apparatus as described above detects from the data received by the receiving means that another door is being driven in order to be re-opened or re-closed with a high-output thrust force, the check means provides a command for switching to a high-output thrust force to the door when a single power source can provide a voltage for providing the high-output thrust force required to properly close the detected other door and the door simultaneously.

According to this configuration, a command for the switching to a high-output thrust force for the door is provided when a single power source can provide a voltage for providing the high-output thrust force required to properly close the detected other door and the door simultaneously when foreign matter is trapped in the door and the door needs to be driven in order to be re-opened or re-closed. As a result, when foreign matter is trapped in the door and the door needs to be driven in order to be re-opened or re-closed, a plurality of doors still can be closed properly.

According to still another aspect of the invention, if the door control apparatus of the invention according to the first aspect detects from the data received by the receiving means that another door is being driven in order to be re-opened or re-closed with a high-output thrust force, the check means provides a command for switching to a high-output thrust force to the door when a single power source can provide both a voltage for providing the high-output thrust force required to properly close the detected other door and the door simultaneously, and the voltage required to properly operate other electrical apparatus.

According to this latter configuration, a plurality of doors can be properly closed when foreign matter is trapped in the door and the door needs to be driven in order to be re-opened or re-closed. Furthermore, adverse effects on other electrical apparatus are prevented even when a power source connected to the doors is also connected to other electrical apparatus (e.g., a fluorescent lamp, an air-conditioning apparatus).

As described above, the invention provides an effect that allows, when trash or deformation of the rubber or the like attached to the end of the door that will not cause an accident makes the door difficult to close, the door to be properly closed in a manner in which the reduction in the voltage of the power source is prevented and that can prevent adverse effects on the operation of other electrical apparatus provided in the same compartment in which the door is provided.

### BRIEF DESCRIPTION OF THE DRAWINGS

FIG. 1 is a block diagram illustrating the configuration of a door driving control apparatus according to an embodiment of the invention.

FIG. 2 is a block diagram illustrating the configuration of a driving-command calculator of the door driving control apparatus according to the embodiment of FIG. 1.

FIG. 3 shows the configuration of the door status data used for the door driving control apparatus according to the embodiment of FIG. 1.

FIG. 4 shows the door driving control apparatus according to the embodiment of FIG. 1, in which door status data is transmitted from one door driving control apparatus and is received by other door driving control apparatuses.

FIG. 5 is a timing chart illustrating an example of the timing of switching between a high-output thrust force command value and a normal thrust force command value by the thrust force switching section of the door driving control apparatus according to the embodiment of FIG. 1.

FIG. 6 shows an example of a door address assigned to each door controlled by the door driving control apparatus according to the above embodiment.

FIG. 7 shows the configuration of the timer table included in the other door status checking section of the door driving control apparatus according to the embodiment of FIG. 1.

FIG. 8 is a first flowchart illustrating an operation for controlling the driving of compartment doors by the door driving control apparatus according to the embodiment of FIG. 1 when foreign matter is trapped in a compartment door.

FIG. 9 is a second flowchart illustrating an operation for controlling the driving of compartment doors by the door driving control apparatus according to the embodiment of FIG. 1 when foreign matter is trapped in a compartment door.

FIG. 10 shows the configuration of the connections among the door driving control apparatuses, the power source, and other electrical apparatus in a single compartment.

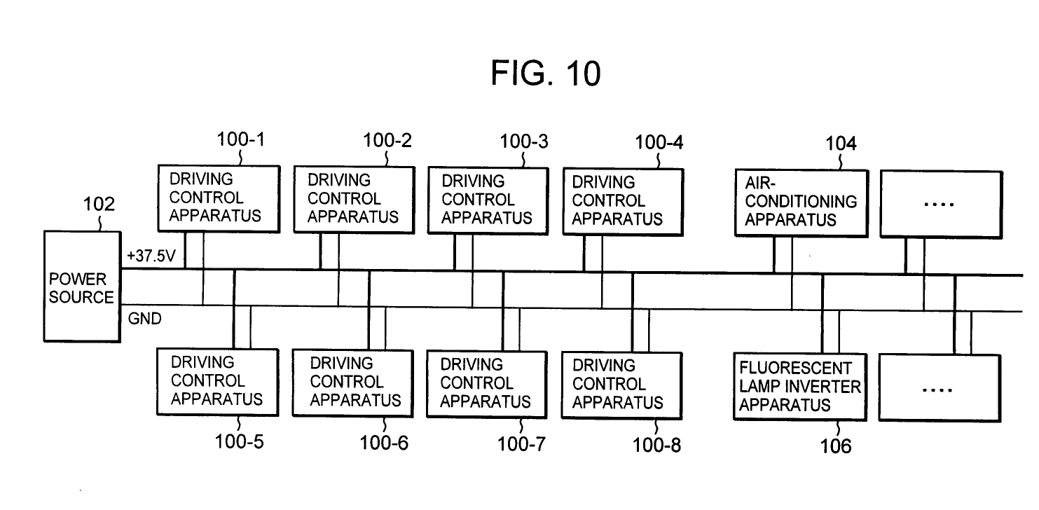

### DETAILED DESCRIPTION OF THE PREFERRED EMBODIMENT

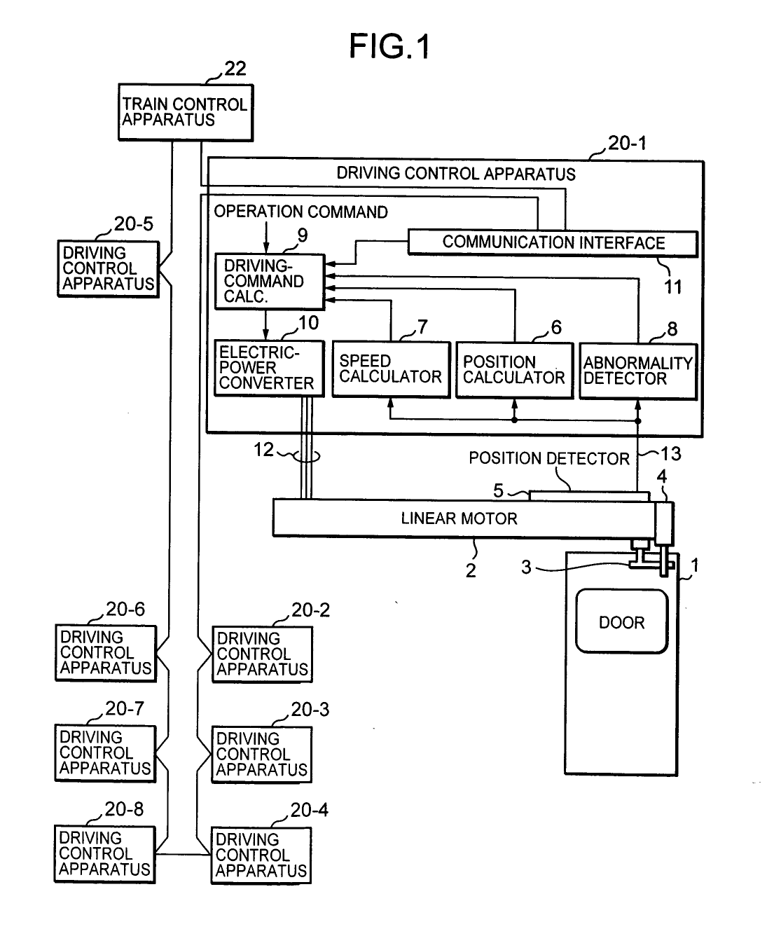

Hereinafter, embodiments of the invention will be described with reference to the drawings. FIG. 1 is a block diagram illustrating the configuration of a door driving control apparatus according to an embodiment of the invention. As shown in FIG. 1, the door driving control apparatuses 20-1 to 20-8 (eight in number, for example), each having the same configuration, are provided at the upper part of the compartment body of one compartment, for example a passenger compartment of a train car. The door driving control apparatuses 20-1 to 20-8 are serially connected via a network to the train control apparatus 22 for controlling the status of the compartment. As can be seen from the representative illustration of the details of the first door driving control apparatus 20-1, each door driving control apparatus includes a position calculator 6, a speed calculator 7, an abnormality detector 8, a driving-command calculator 9, an electric-power converter 10, and a communication interface section 11.

The door driving control apparatus 20-1 is also connected to a linear motor 2 for driving the opening and closing of a door 1, and a position detector 5 for detecting the position of the movable section of this linear motor 2 via electric wirings 12 and 13. The door 1 is linked by the movable section of the linear motor 2 and a linkage section 3, and is further combined with a lock apparatus 4 for mechanically fixing the door 1. This mechanism for driving of the opening and closing of the door 1 is the same as those of the door driving control apparatuses 20-2 to 20-8. Thus, for the sake of simplifying the drawings, the mechanism for the door driving control apparatuses 20-2 to 20-8 are not shown in the drawing.

The position detector 5 detects the movement of the movable section of the linear motor 2 to output a detected signal via the electric wiring 13 to the position calculator 6, the speed calculator 7, and the abnormality detector 8. The position calculator 6 uses the detected signal output from the position detector 5 to calculate the position of the door 1. The speed calculator 7 uses the detected signal output from the position detector 5 to calculate the opening and closing speeds of the door 1.

The abnormality detector 8 detects abnormalities caused when the detected signal of one or both of the position and speed output from the position detector 5 has a value that differs by a predetermined difference from a value corresponding to the position and speed to be controlled. That is, if the detected speed of the door is outside a predetermined range or the detected position of the door is outside a predetermined range, or both, the detector 8 judges that an abnormality exists. When detecting such abnormality, the abnormality detector 8 outputs an abnormality detection signal to the driving-command calculator 9.

The driving-command calculator 9 normally provides the control described below in addition to the featured control of this embodiment (which will be described in detail later). Specifically, when the communication interface section 11 or an external apparatus (not shown) inputs a door driving command to the driving-command calculator 9, the driving-command calculator 9 calculates an electric power-supply command to be supplied to the converter 10 for supplying power to the linear motor 2, based on the door-position information calculated by the position calculator 6, the door-speed information calculated by the speed calculator 7, and the abnormality information on the detected signal detected by the abnormality detector 8. In other words, the driving-command calculator 9 controls the driving of the opening and closing of the door 1.

In accordance with the electric-power-supply command calculated by the driving-command calculator 9, the electric-power converter 10 supplies electric power to the linear motor 2. The linear motor 2 uses the electric power for opening and closing door 1.

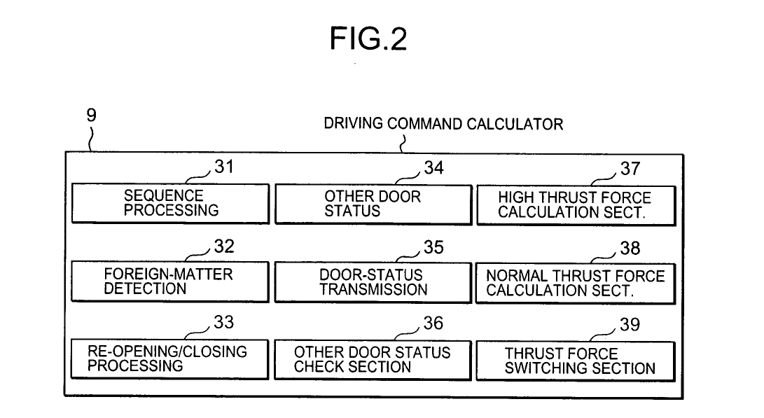

As shown in FIG. 2, according to this embodiment, the driving-command calculator 9 further includes a basic sequence-processing section 31, a foreign-matter detection section 32 and a re-opening and re-closing processing section 33. The calculator 9 further includes a status receiving section 34 for receiving data on the statuses of the respective other doors, a transmission section 35 for transmitting door-status, a checking section 36 that checks the status of the other doors, a high thrust force calculation section 37 for calculating the thrust force in the event of foreign-matter detection, a thrust force calculation section 38 for calculating thrust force when the door is in a normal status, and a thrust force switching section 39.

The basic sequence-processing section 31 for the door is used to process a door open command, a door close command, the operation of an emergency lever, and the like. The foreign-matter detection section 32 detects foreign matter trapped in the door based on the deviation between the position of the door according to the command and the actual position of the door. The foreign-matter detection section 32 uses this information as to the position of the door in relation to the command to assess whether it is most likely that an object larger than a predetermined size, which may cause an accident (e.g., a human, a bag; hereinafter also referred to as “large foreign matter”) is trapped in the door, or a small object that will not cause an accident (e.g., trash; hereinafter also referred to as small foreign matter) is trapped in the door.

When the foreign-matter detection section 32 detects, based upon the detected deviation, that most likely a large-sized foreign matter is trapped in the door, the re-opening and re-closing processing section 33 performs processing for opening the door based on the basic sequence-processing section 31 (automatic re-opening and re-closing processing). Manual re-opening and re-closing processing is performed by a person, e.g. train conductor, when the person finds that a human or an object is trapped in the door.

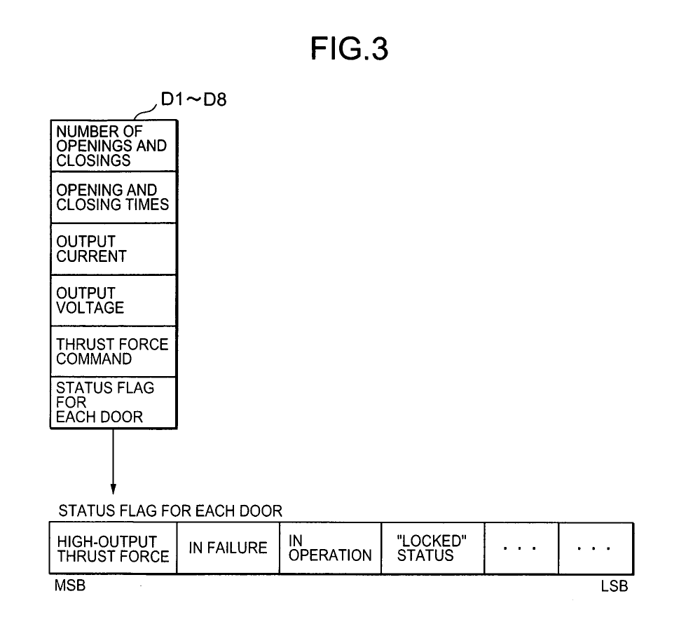

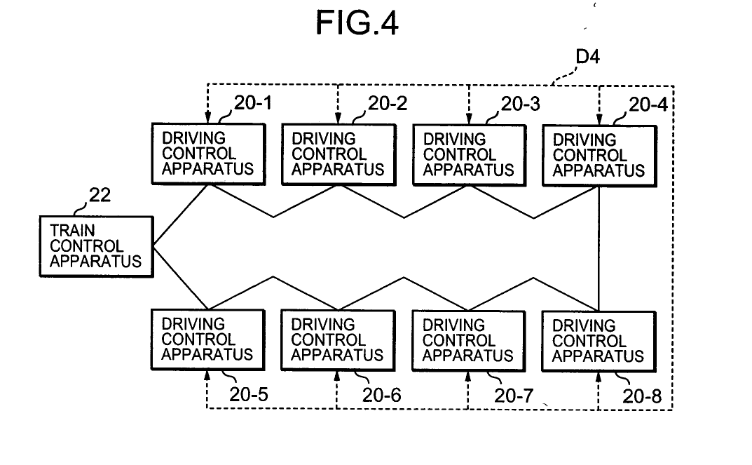

The door-status transmission section 35 transmits door status data to the door driving control apparatus for each of the other seven doors in the manner indicated by the broken line in FIG. 4. The door status data shows the status of the door and has the configuration shown in FIG. 3. Similarly, in each of the other door driving control apparatuses, the other door status receiving section 34 thereof receives and stores the door status data showing the status of the door that transmitted such data. FIG. 4 shows a case in which the fourth door driving control apparatus 20-4 transmits the door status data D4 regarding that fourth door, and the other door driving control apparatus receives such transmitted door status data D4.

As shown in FIG. 3, the door status data is represented as follows. The door status data D1 regards the first door, the door status data D2 regards second door, and similarly the door status data D8 regards the eighth door. The door status data D1 to D8 are composed of information, i.e., the number of openings and closings, opening and closing times, the output current, the output voltage, the thrust force command, and a status flag.

As shown in FIG. 3, one status flag is composed of information regarding the following status conditions: the output of high-output thrust force, being in failure, being in operation, or being “locked”. It should be noted that the status flag, while a high-output thrust force is being output, for example, has a value of “1” in the applicable space.

Each door control apparatus holds separate status flags for all doors. For example, as to the first door, a door-status transmission section 35 of the first door transmits a status of the first door to the other doors. Further, statuses of the other doors 2-8 go through the other door status receipt section 34, and such respective statuses are stored in the corresponding status flag of the respective doors 2-8.

The door-status transmission section 35 normally transmits information to the train control apparatus 22. In the case of a system having slave—slave communication, information is directly transmitted to another door driving control apparatus. Specifically, when transmitting the data as to the status of the door, the door-status transmission section 35 is designed so as to transmit the data via the train control apparatus 22, or to transmit the data to the other door driving control apparatuses directly.

The other door status receiving section 34 receives the data indicating the status of the other doors. As shown in FIG. 1, a door normally is connected via a network to the train control apparatus 22 in order always to transmit the door status data to the train control apparatus 22 (master—slave communication). This communication method includes a frequently used RS-485 serial port method and a frequently used High-Level Data Link Control (HDLC) Procedure. This circuit is used to monitor the communication. In the case of a system having slave-slave communication (e.g., LONWORKS by Echelon), direct transmission to another door is possible. In other words, when receiving the door status data regarding another door, the other door status receiving section 34 is designed to receive the data via the train control apparatus 22 or directly to receive the data from the other door driving control apparatus.

The high thrust force calculation section 37 calculates the thrust force command value (high-output thrust force command value) for foreign-matter detection, which is used when small foreign matter is trapped and detected. The thrust force calculation section for normal status 38 calculates the thrust force command value (normal thrust force command value), which is used when normal door opening and closing operations are performed.

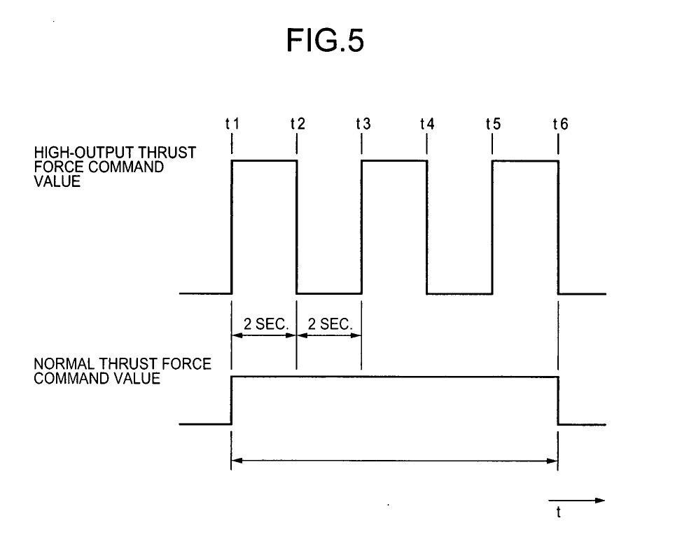

Based on the detection by the foreign-matter detection section 32 or a checking result obtained by the other door status checking section 36 (which will be described later), the thrust force switching section 39 provides switching between a normal thrust force command and a high-output thrust force command. This switch processing provides the switching between a high-output thrust force command value and a normal thrust force command value every two seconds during the periods t1 to t6, while small foreign matter is being detected, as shown in FIG. 5, for example.

When a thrust force command to the door is switched to a high-output thrust force command by the thrust force switching section 39, the other door status checking section 36 checks the status of the other doors based on the door status data of the other doors received by the other door status receiving section 34. When a status in which small foreign matter is trapped not only by the door but also by one or more of the other doors is found, such doors other than that switched to first have the high-output thrust force command stop outputting a high-output thrust force command, and are placed in a standby status. Then, an output checking section delay timer provided in the other door status checking section 36 is started to wait for a fixed time. Thereafter, the other door status receiving section 34 again receives the door status data of the other door to check the status of the other door. This adjustment processing prevents a plurality of doors from receiving high-output thrust force commands simultaneously.

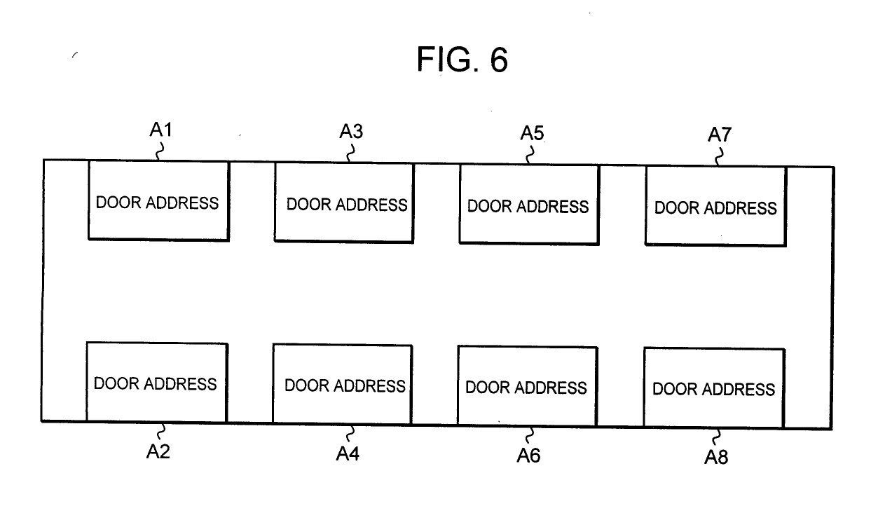

As shown in FIG. 6, the door addresses A1 to A8 corresponding to the positions of the doors are determined, for example. The door driving control apparatuses 20-1 to 20-8 are attached at positions corresponding to the positions of the door addresses A1 to A8 for transmission. The respective door driving control apparatuses 20-1 to 20-8 have other door status checking sections 36 that calculate the door addresses A1 to A8 based on the positions of the respective doors.

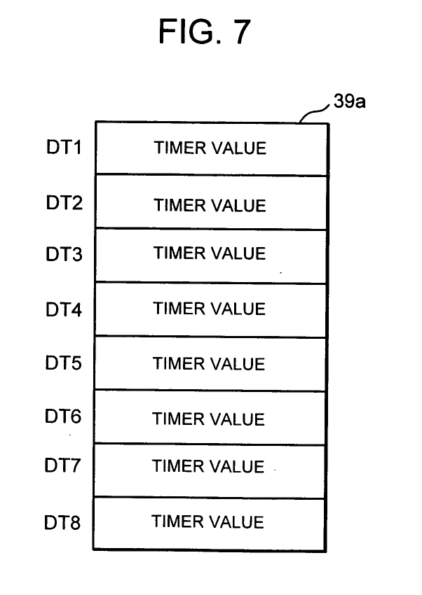

The other door status checking section 36 also sends the result of the checking of the high-output thrust force generation status of other doors in order to adjust a case in which foreign matter is detected in a plurality of doors. This is provided by the illustrative configuration shown in FIG. 7, in which the other door status checking section 36 includes the timer table 36a in which respective timer values DT1-DT8 of the delay timers of the respective doors D1-D8 are stored according to the door addresses A1 to A8. In this way, the other door status checking section 36 of each of the door driving control apparatuses 20-1 to 20-8 reads an applicable timer based on the addresses A1 to A8 of the timer table 36a corresponding to the door address A1 to A8 calculated based on the position of the door.

This timer value is used for the shown processing in FIG. 5 for switching between a high-output thrust force command value and a normal thrust force command value. The timer value depends on the door addresses A1 to A8. Thus, the time of processing the other door status checking section 36 for the adjustment also depends on the door driving control apparatuses 20-1 to 20-8, thus spreading out the times at which the output of a high-output thrust force is requested.

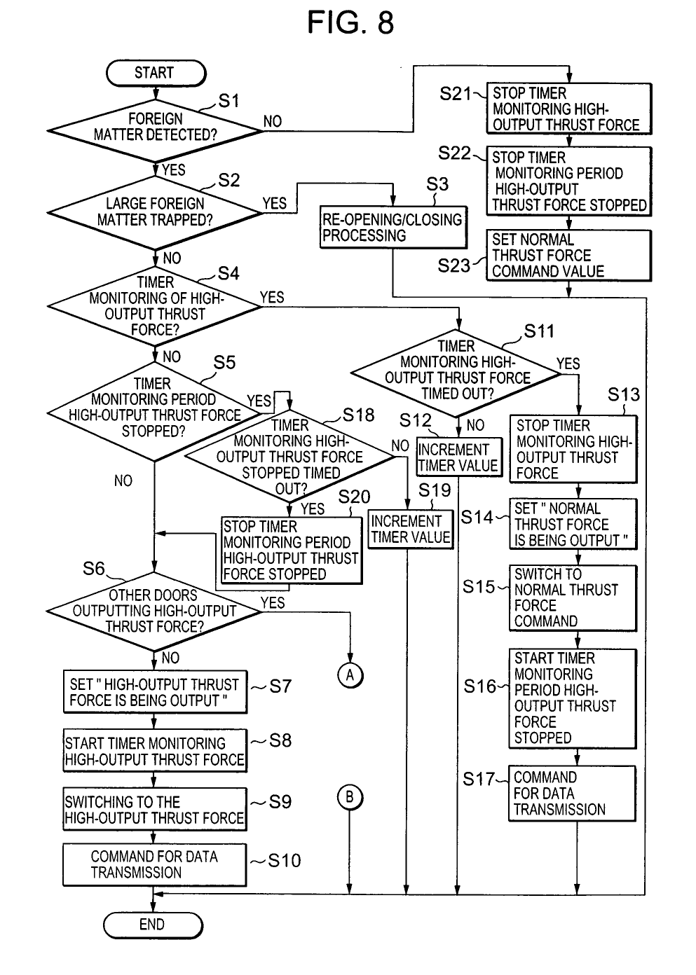

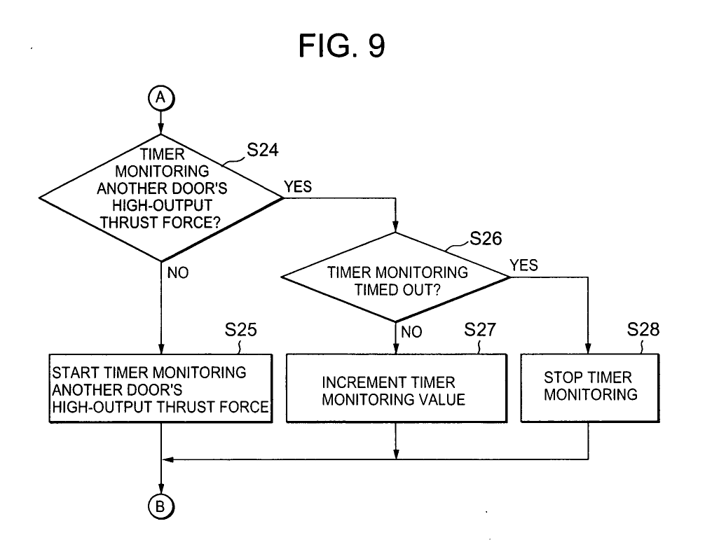

Next, an operation in which the door driving control apparatus having such a configuration is used to control the driving of the door when foreign matter is trapped in a compartment door will be described with reference to the flowchart shown in FIGS. 8 and 9.

Step S1 shown in FIG. 8 determines whether the foreign-matter detection sections 32 of the door driving control apparatuses 20-1 to 20-8 detected that the corresponding door has trapped foreign matter. When step S1 determines that foreign matter is trapped, step S2 uses the above foreign-matter detection section 32 of the corresponding door to judge whether large foreign matter equal to or larger than a predetermined size (e.g., a human, a bag) is trapped. When step S2 judges that large foreign matter is trapped, step S3 allows the re-opening and re-closing processing section 33 to provide automatic re-opening and re-closing processing or manual re-opening and re-closing processing, thereby re-opening and re-closing the doors.

On the other hand, when it is judged that no large foreign matter is trapped, but that small foreign matter is trapped, step S4 allows the other door status checking section 36 to check whether a timer for monitoring the output of a high-output thrust force using a delay timer (a timer for monitoring whether the output of a high-output thrust force is provided for a fixed time) is operated. When the timer is in a stop status, step S5 allows the other door status checking section 36 to determine whether a timer for monitoring the period during which a high-output thrust force is stopped using a delay timer (a timer for monitoring, when foreign matter is detected, the period during which a high-output thrust force is not output) is operated.

When the timer is not in operation, step S6 allows the other door status checking section 36 to judge, based on all other door status data for the same compartment received by the other door status receiving section 34, whether any other doors output a high-output thrust force. When it is judged that the other doors do not output a high-output thrust force, step S7 allows the thrust force switching section 39 to specify that a high-output thrust force command is being provided. Then, step S8 allows the other door status checking section 36 to start the timer for monitoring the output of a high-output thrust force.

Thereafter, step S9 allows the thrust force switching section 39 to provide the switching to a high-output thrust force. Step S1 transmits door status data indicating that a high-output thrust force is being output from the door-status transmission section 35 to other door driving control apparatuses. This transmitted door status data is received by each other door driving control apparatus, thus preventing the other doors from outputting a high-output thrust force even when foreign matter is detected.

When the timer for monitoring the output of a high-output thrust force is in operation in the above step S4, step S11 allows the other door status checking section 36 to check whether the timer for monitoring the output of a high-output thrust force is timed out in order to judge whether a high-output thrust force has been output for a fixed time. When it is judged that the timer is not yet timed out, step S12 increments the timer for monitoring the output of a high-output thrust force.

When, on the other hand, it is judged that the timer is timed out, step S13 stops the timer for monitoring the output of a high-output thrust force. Then, step S14 allows the thrust force switching section 39 to specify that a normal thrust force is being output. Step S15 provides switching to a normal thrust force command. Step S16 allows the other door status checking section 36 to start the timer for monitoring the period during which a high-output thrust force is stopped. Step S17 sends the door status data indicating that a normal thrust force is being output from the door-status transmission section 35 to each other door driving control apparatus.

When the above step S5 judges that the timer for monitoring the period during which a high-output thrust force is stopped is in operation, step S18 checks whether the timer for monitoring the period during which a high-output thrust force is stopped is timed out in order to judge whether the stop period has been provided for a fixed length of time. When it is judged that the timer is not timed out (i.e., the stop period for a fixed time is not yet expired), step S19 increments the timer value of the timer for monitoring the period during which a high-output thrust force is stopped. When, on the other hand, it is judged that the timer is timed out (specifically, foreign matter is detected but the output of a high-output thrust force is stopped for a fixed length of time), step S20 stops a timer for monitoring the period during which a high-output thrust force is stopped. Then, a determination by step S6 is provided.

When foreign matter is removed while a high-output thrust force is being output, the above step S1 judges that foreign matter is not detected. Then, step S21 stops the timer for monitoring the output of a high-output thrust force if the timer is in operation. Step S22 stops the timer for monitoring the period during which a high-output thrust force is stopped if the timer is in operation. Then, step S23 sets a normal thrust force command value. This allows the thrust force switching section 39 to provide the switching to the normal thrust force command, and the switching to a normal thrust force mode is provided.

When the above step S6 judges that the other door status checking section 36 detects a high-output thrust force being output by another door, the processing proceeds to step S24 shown in FIG. 9. This step S24 allows the other door status checking section 36 to judge whether a timer for monitoring the output of a high-output thrust force of another door is in operation. When the timer is not in operation, step S25 starts the timer for monitoring the output of the high-output thrust force of another door.

When, on the other hand, step S24 judges that the timer for monitoring the output of a high-output thrust force of another door is being operated, step S26 judges whether the timer for monitoring the output of a high-output thrust force of another door is timed out. When the timer is not yet timed out, step S27 increments the timer for monitoring the output of a high-output thrust force. When the timer is timed out, step S28 stops the timer for monitoring the output of a high-output thrust force.

In this way, the door driving control apparatus according to this embodiment allows, when the foreign-matter detection section 32 detects that small foreign matter is trapped in a door, the other door status receiving section 34 to receive the door status data of other doors. The switching to a high-output thrust force for the door is ordered when the other door status checking section 36 detects from the received door status data that other doors are not driven in order to be re-opened or re-closed with a high-output thrust force.

As a result, only one door is always driven in order to be re-opened or re-closed when foreign matter is trapped in a door and the door needs to be driven in order to be re-opened or re-closed. This prevents a plurality of doors connected via wiring to one power source 102 provided in the same compartment from having a reduction in voltage of the power source caused as in a conventional configuration in which a plurality of doors are driven in order to be re-opened or re-closed simultaneously, thus properly closing the doors. By preventing the reduction in the voltage of the power source as described above, adverse effects on other electrical apparatus are prevented even when a power source connected to a plurality of doors also is connected to other electrical apparatus (e.g., a fluorescent lamp, an air-conditioning apparatus).

When the other door status checking section 36 detects from the door status data received by the other door status receiving section 34 that another door is being driven in order to be re-opened or re-closed with a high-output thrust force, a command for the switching to a high-output thrust force for the door may be provided when the power source 102 can provide a voltage for providing a high-output thrust force required to properly close the detected other door and the door simultaneously. In this way, a command for switching to a high-output thrust force for the door can be provided when foreign matter is trapped in the door and the door needs to be driven in order to be re-opened and re-closed, and when the power source 102 can provide a voltage for providing a high-output thrust force required to properly close the detected other door and the door simultaneously. This allows a plurality of doors to be properly closed when foreign matter is trapped in the doors and the door needs to be driven in order to be re-opened and re-closed.

When the other door status checking section 36 detects from the door status data received by the other door status receiving section 34 that another door is being driven in order to be re-opened and re-closed with a high-output thrust force, then a command for switching to a high-output thrust force for the door may be provided when a single power source can provide both a voltage for providing the high-output thrust force required to properly close the detected other door and the door simultaneously, and a voltage required to properly operate other electrical apparatus. As a result, when foreign matter is trapped in the doors and a plurality of doors need to be driven in order to be re-opened and re-closed, adverse effects on other electrical apparatus can be prevented even when the power source 102 connected to the plurality of doors is also connected to other electrical apparatus (e.g., a fluorescent lamp, an air-conditioning apparatus).

This application incorporates by reference the entire disclosure of applicants' corresponding Japanese patent application, Serial No. JP-PA 2003-385607, filed Nov. 14, 2003.

1. A door driving control apparatus, for controlling driving by an electric motor of opening and closing of one door in a compartment, the door driving control apparatus detecting trapped in the one door small foreign matter of a size equal to or smaller than a predetermined size, and responsive thereto switching a thrust force for driving opening and closing of the one door to a high-level output thrust force to re-open and re-close the one door, the door driving control apparatus comprising:
means for transmitting door status data indicating a status of the one door to another door driving control apparatus for controlling an other door in the same compartment;
means for receiving the door status data of the other door transmitted from a transmitting means of the other door driving control apparatus; and
check means for allowing, when the foreign matter is judged to be trapped in the door, the receiving means to receive the door status data of the other door, and for sending, when detecting from this door status data that the other door is not being driven in order to be re-opened or re-closed with a high-output thrust force, a command for switching to a high-output thrust force for the one door.

2. A door driving control apparatus according to claim 1, wherein when the check means detects from the data received by the receiving means that a high-output thrust force is being applied to re-open or re-close the other door, then the check means provides a command for switching to a high-output thrust force to the door when a single power source can provide a voltage for providing the high-output thrust force required to properly close the detected other door and the one door simultaneously.

3. A door driving control apparatus according to claim 1, wherein when the check means detects from the data received by the receiving means that the other door is being driven in order to be re-opened or re-closed with a high-output thrust force, the check means provides a command for switching to a high-output thrust force to the one door when a single power source is capable of providing both a voltage for providing a high-output thrust force required to properly close the detected other door and the one door simultaneously, and a voltage required to properly operate other electrical apparatus.

4. A door driving control apparatus for driving a first motor that opens and closes a first door in a compartment, the compartment additionally having at least one second door that is opened and closed by a corresponding second motor, said door driving control apparatus comprising:
first means for detecting trapped in the first door an object that is equal to or smaller than a predetermined size;
second means, responsive to the first means, for switching at torque thrust force to drive the first motor to a high-level thrust force to re-open or re-close the first door;
means for transmitting door status data indicating a status of the first door to the at least one second door driving control apparatus for use by the at least one second door driving control apparatus in controlling the at least one second door;
means for receiving door status data of the at least one second door transmitted from transmitting means of the at least one second door driving control apparatus; and
check means for allowing, when the foreign matter is judged to be trapped in the first door, the receiving means to receive the door status data of the at least one second door, and for sending, when detecting from this second door status data that the at least one second door is not being driven in order to be re-opened or re-closed with a high-output thrust force, a command for switching to a high-output thrust force for application to the first door.

5. A door driving control apparatus for driving a first motor that opens and closes a first door in a compartment, the compartment additionally having at least one second door that is opened and closed by a corresponding second motor controlled by a corresponding second door driving control apparatus, comprising:
first means for detecting an object that is equal to or smaller than a predetermined size trapped in the first door;
second means, responsive to the first means, for switching a thrust force to drive the first motor to a high-level thrust force to re-open or re-close the first door, the second means including
means for transmitting door status data indicating a status of the first door to the at least one second door driving control apparatus for controlling the at least one second door,
means for receiving door status data of the at least one second door transmitted from the corresponding second door driving control apparatus, and
check means for allowing, when the first means detects an object equal to or smaller than the predetermined size trapped in the first door, the receiving means to receive the door status data of the at least one second door, and for sending, when detecting from this door status data that the at least one second door is not being driven in order to be re-opened or re-closed with a high-output thrust force, a command for switching to a high-output thrust force for application to the first door.
